(19) United States
(12) Patent Application Publication
(10) Pub. No.: US 2009/0000994 A1
(43) Pub. Date: Jan. 1, 2009

(54) Sieve, Sifter, and Sieve Breakage Detector

(75) Inventors: Fumio Kato, Aichi (JP); Hitoshi Hanada, Aichi (JP)

Correspondence Address: RODMAN RODMAN, 10 STEWART PLACE, SUITE 2CE, WHITE PLAINS, NY, 10603, US

(73) Assignee: TSUKASA INDUSTRY CO., LTD., Aichi (JP)

(21) Appl. No.: 11/577,071

(22) PCT Filed: Oct. 6, 2005
(86) PCT No.: PCT/JP2005/018518

§ 371 Date: Aug. 22, 2008

(30) Foreign Application Priority Data
Oct. 18, 2004 (JP) 2004-303581

(51) Int. Cl. B07B 1/00; G01N 1/00

(52) U.S. Cl. 209/363; 73/863.23

(57) ABSTRACT

The present invention aims to detect breakage of a sieve in real-time and thus substantially reduce a cost increase of products caused by sieve breakage. The present invention also aims to reduce management cost of a sieve substantially.

Multiple conductive bands 40 through 51 of a predetermined width, composed of multiple (for example, ten, in the structure shown in the figures) conductive weaving threads 24 and multiple (for example, ten) nonconductive weaving threads 23 and a certain number of nonconductive weaving threads 25, are formed in one area of the screen member 5. These conductive bands 40 through 51 of combined weave are formed parallel to the axial direction X at certain intervals D. Between each conductive band 40 through 51, nonconductive bands 52 through 62 plane-woven by using the nonconductive weaving threads 23 and the nonconductive weaving threads 25 are formed. A continuous conductive element 82 of a folded shape is formed, as shown in FIGS. 4 and 5 by connecting adjacent ends of the multiple conductive bands 40 through 51 alternatively using conductive members 70 through 80 (conductive tapes made, for example, of thin cupper sheet).

### TECHNICAL FIELD

The present invention relates to a sieve which is applied to a sifter for screening particles and detects breakage of the sieve by utilizing electrical change caused by breakage of the sieve, a sifter comprising the sieve, and a sieve breakage detector.

### BACKGROUND ART

In the invention described in Patent Document 1, a high frequency wave detecting sensor is set in the vicinity of a screen. High frequency waves, to which frequency domain of breakage sound of the metal screen of the sieve belongs to, are detected and amplified. Then the sound pressure level of the signal is compared with a preset standard level for judgment. If it exceeds the standard level, an alarm sound is generated or operation of the sieve is stopped.

In the method and system for detecting sieve breakage described in Patent Document 2, ultrasonic waves are used to detect breakage of a sieve. Unlike with the invention of Patent Document 1, this invention provides an easy system, wherein complicated signal processing is not necessary, malfunction or failure in detecting does not occur, and setting of the standard level after breaking test is not necessary. Breakage of the sieve causes deformation of the sieve, and this causes change in vibration of the sieve. In this invention, electrical change in power supplied to an ultrasonic transducer caused by change in vibration is detected for breakage detection.

[Patent Document 1] Kokoku (Japanese examined patent publication) No. H-4-46867
[Patent Document 2] Kokai (Japanese unexamined patent publication) No. H-11-290781

### DISCLOSURE OF THE INVENTION

### Problems to be Solved by the Invention

However, in the invention described in Patent Document 1, it is necessary to process signals when detecting high frequency waves. This results in a delay in detection time. A sieve set in an inline type sifter built in an automatic powder feeding line cannot be inspected before a production process ends. Accordingly, in the case where breakage of the sieve occurs, and thus screening function is deteriorated, or broken pieces or foreign substances are mixed into the production, breakage time can not be determined. In the worst case, a whole process has already ended, and disposal of the whole production in the production process is needed.

In a bread plant, for example, prescribed one batch of powder is fed to a mixer and is made into dough in the mixer. One lot is consisted of several batches. If a production process is consisted of ten batches, the ten batches are processed continuously, and the sieve cannot be inspected during the process. It is too late if breakage of the sieve is found by inspecting the internal of the sieve after the ten batches had ended. There is no way to know during which batch the sieve broke. Usually, a process is carried on assuming that the sieve is intact without breakage. By the nature of things, there are such situations as some productions must be delivered by a certain time in a sales channel . . . . Bread making processes are carried on assuming that the sieve is intact. If breakage of the sieve is found, it is necessary to dispose all of the packed bakery goods corresponding to the ten batches.

In the invention described in Patent Document 2, it is necessary to detect breakage in a static condition to avoid the influence of change in tension of the sieve caused by movement of particles during operation of the vibration sieve. Accordingly, real-time sieve breakage detection in a dynamic condition, in which, for example, particles are discharged continuously, is difficult. Accordingly, continuous surveillance is difficult.

Moreover, if an inspection door, through which the sieve can be inspected from outside of the machine, is provided, particles would adhere to the inspection door or the sieve itself, making surveillance of breakage status of the sieve difficult. Moreover, cost for the surveillance is expensive.

By taking into account the drawbacks of the prior art structures discussed above, the present invention aims to detect breakage of a sieve in real time and thus prevent loss of production caused by breakage of the sieve and also aims to substantially reduce management cost of the sieve.

### Means for Solving the Problems

To solve the above-mentioned problems, an invention disclosed in claim 1 is a sieve comprising a cylindrical or plane screen woven with nonconductive warp threads and nonconductive weft threads, wherein multiple bands composed of one or more conductive weaving thread(s) are combined woven all over said screen or in an area of said screen along with either the warp threads or the weft threads of said screen, and a continuous conductive element of a folded shape is formed by connecting adjacent ends of said multiple bands alternatively using (a) conductive member(s).

For example, a monofilament made of nylon or polyester and so on is preferable as the nonconductive weaving thread. For example, a weaving thread made of carbon fiber is preferable as the conductive weaving thread. Plain weave or twill weave is preferable. The nonconductive weaving threads are preferably combined woven along with either the nonconductive warp threads or the nonconductive weft threads (not along with both of them). The conductive threads may be combined woven in an area of the screen where probability of breakage is high or may be combined woven all over the screen. Each of said multiple bands may be composed of conductive weaving threads and nonconductive weaving threads woven in a same direction or may be composed of multiple conductive weaving threads alone. Said conductive element is preferably a band-shaped element or a combined element of a band-shaped element and a line-shaped element.

An invention disclosed in claim 2 is a sieve in accordance with claim 1, . . . wherein a ring-shaped member is formed at both ends of the axial direction of said cylindrical screen or a frame-shaped member is formed around said plain screen, said ring-shaped member or said frame-shaped member is supported by a ring-shaped holder in a attachable and detachable manner, said ring-shaped holder holds ends of said conductive element, and said conductive member is protected by an insulating member.

The ring-shaped member or the frame-shaped member is preferably a band member (such as a cloth or a tape) that pinches the screen from the outside and the inside of the screen at each end.

An invention disclosed in claim 3 is a sifter comprising the sieve in accordance with either claim 1 or claim 2.

The sifter disclosed in claim 3 is applicable to an inline type sifter or a non inline type sifter such as a vibration sifter. The sieve set in an inline type sifter preferably has a cylindrical shape. The sieve set in a vibration sifter may have a circular shape or a polygonal shape.

An invention disclosed in claim 4 is a sieve breakage detector comprising: a resistance meter or a voltmeter which is provided with terminals connected to at least two points of said conductive element of the sieve in accordance with either claim 1 or claim 2 and which measures resistance or voltage of said conductive element, and a judging part which judges that breakage has occurred in said area of the screen when the measured resistance or voltage changes greater than a preset value.

### ADVANTAGEOUS EFFECTS OF THE INVENTION

According to the invention disclosed in claim 1, breakage of the sieve can be detected in real time. This enables to remove only the production corresponding to the process in which breakage occurred, resulting in a reduction of loss of production and thus resulting in a substantial reduction of production cost. Additionally, breakage status of the sieve can be known without check with eyes. This results in a substantial reduction of management cost.

According to the invention disclosed in claim 2, insulation of the conductive element can be ensured by a simple structure.

According to the invention disclosed in claim 3, a sifter having the same advantageous effects as the sieve in claim 1 can be realized.

According to the invention disclosed in claim 4, breakage of the sieve can be detected by connecting the resistance meter or the voltmeter to the conductive element and measuring resistance or voltage of the conductive element. This provides a versatile system without necessity of a sifter with a special specification.

### BRIEF DESCRIPTION OF THE DRAWINGS

FIG. 1 is a perspective view showing a cylindrical sieve in a first embodiment of the invention.

FIG. 2(a) is a front view of a screen member; FIG. 2(b) is a vertical section of a ring-shaped member of the screen member; FIG. 2(c) is a vertical section of the screen member; FIG. 2(d) is an enlarged partial front view of the ring-shaped member.

FIG. 3 is an enlarged view showing a texture of the screen.

FIG. 4 shows the screen in an opened position.

FIG. 5 shows a conductive element in an opened position.

FIG. 6 shows a configuration of the conductive element and conductive wires.

FIG. 7 is a partial front view of the screen member.

FIG. 8 is an enlarged partial vertical section of the ring-shaped member.

FIG. 9(a) is an enlarged view showing a fixation part of the screen member and an outgoing wire; FIG. 9(b) is an enlarged side view of the same fixation parts.

FIG. 10 is a block diagram showing the screen member with the conductive element and a sieve breakage detector connected to the screen member.

FIG. 11 is a block diagram of the sieve breakage detector.

FIG. 12(a) is a plan view of a polygonal vibration sieve in a second embodiment of the invention; FIG. 12(b) is a side view of the same.

FIG. 13(a) is a plan view of the screen member in a second embodiment of the invention; FIG. 13(b) is a plan view of a conductive element of the same screen member.

### REFERENCE NUMBER

1 . . . cylindrical sieve 2 . . . screen 3,4 . . . ring-shaped member 5 screen member 6 . . . ring-shaped holder 7 . . . rod 8 . . . first frame 9 . . . second frame 10 . . . fixation element 11 . . . first holder frame 12 . . . fixation element 13 . . . second holder frame 14 . . . guide projection 15 . . . handle 21 . . . radial direction end 22 . . . seam of sieve 31 . . . reinforcement fabric 32 . . . fixing part 33 . . . ring 34 . . . core reinforcement 23 . . . nonconductive weaving threads 24 . . . conductive weaving threads 25 . . . nonconductive weaving threads 40-51 . . . conductive bands 52-62 . . . nonconductive bands 70-80 . . . conductive members 82 . . . conductive element 70a-80a . . . insulating members 84, 86 . . . ends 88, 90 . . . conductive wires 92, 94 . . . electrodes 96 . . . insulator 97 . . . power source 98 . . . power switch 99 . . . adjustable external resistor 100 . . . control part

### BEST MODES FOR CARRYING OUT THE INVENTION

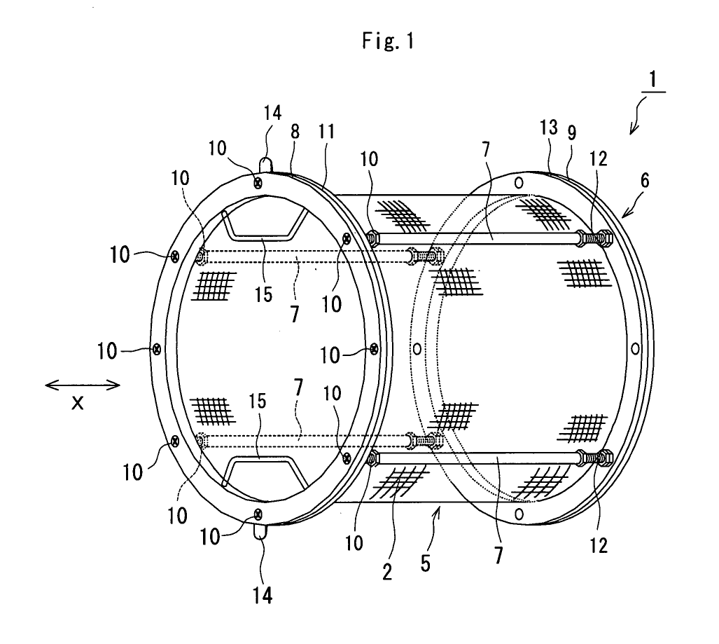

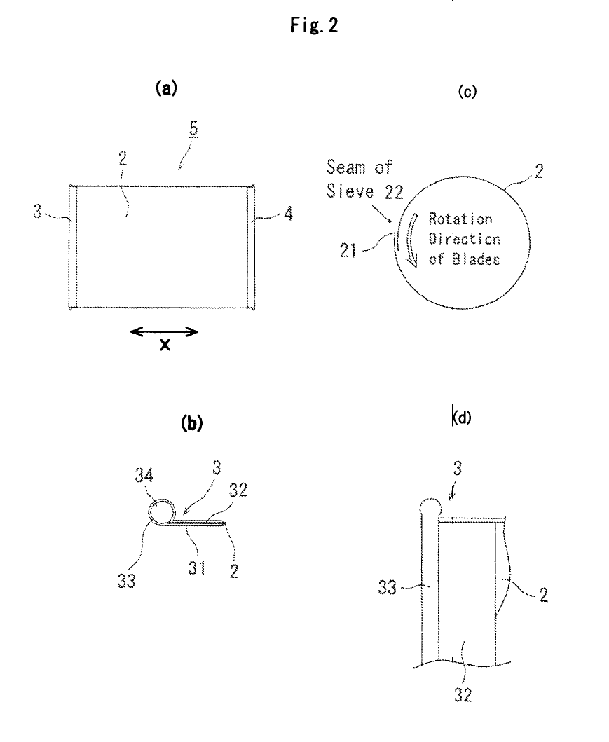

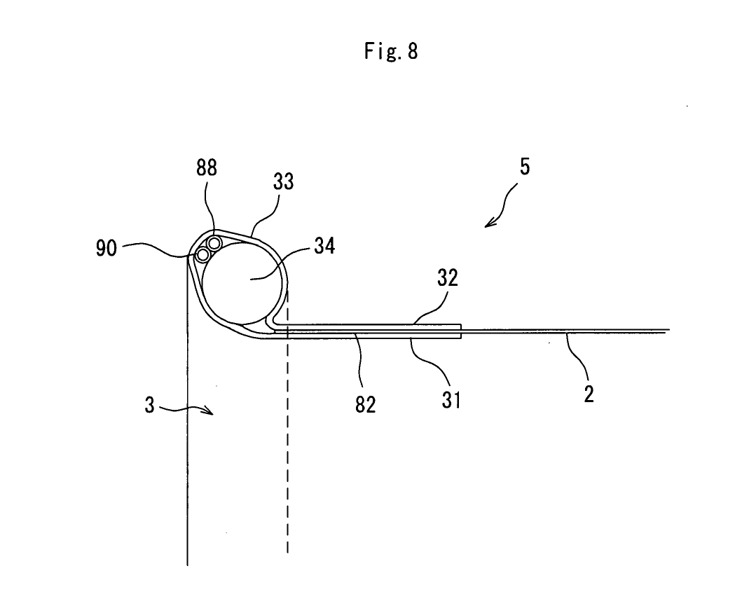

A sieve 1 in a first embodiment of the present invention will be described below with reference to FIGS. 1 through 9. The cylindrical sieve 1 is provided with a cylindrical screen member 5 having a cylindrical screen 2 and a pair of ring-shaped members 3, 4 located at both ends of the axial direction X of the screen 2 as shown in FIG. 2, and a ring-shaped holder 6 holding the ring-shaped members 3 and 4 in an detachable and attachable manner as shown in FIG. 1.

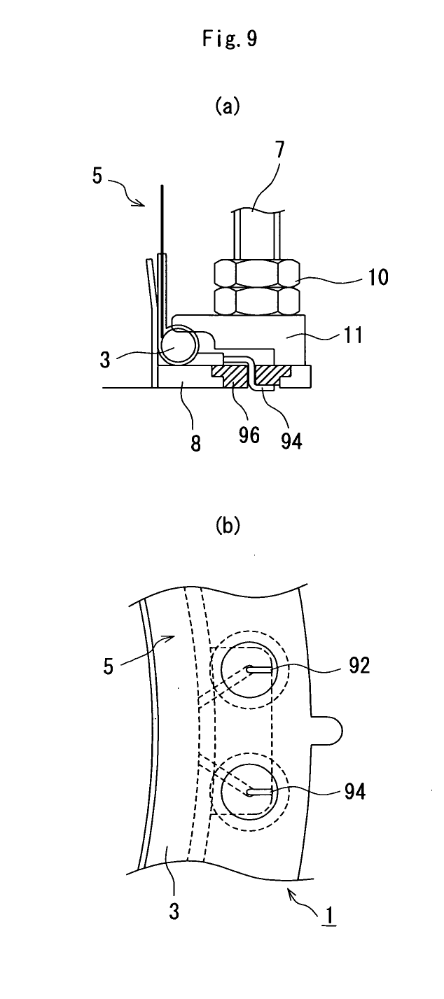

The detailed structure of the ring-shaped holder 6 is shown in the International Publication WO2004/060584A1. The structure of the ring-shaped holder 6 will be described briefly here. The ring-shaped holder 6 is provided with multiple (four in this embodiment) rods 7 having a preset length, extending in the axial direction X, and located with a preset interval in the radial direction, a circular ring-shaped first frame 8 fixed at one end of the rods 7 in a plane orthogonal to the axial direction X, a circular ring-shaped second frame 9 fixed at another end of the rods 7 in a plane orthogonal to the axial direction X, a pair of circular ring-shaped first holder frames 11 that are located in a plane orthogonal to the axial direction X, movable between the first frame 8 and the second frame 9 along the rods 7 in the axial direction X when not in use, and can fixes the ring-shaped member 3 when in use of the sieve 1 in such a manner that the first holder frame 11 and the first frame 8 clamp the ring-shaped member 3 and they are then fixed together by means of fixation elements 10 (see FIG. 9(a)), a pair of circular ring-shaped second holder frames 13 that are located in a plane orthogonal to the axial direction X, movable between the first frame 8 and the second frame 9 along the rods 7 in the axial direction X when not in use, and can fixes the ring-shaped member 4 when in use of the sieve 1 in such a manner that the second holder frame 13 and the second frame 9 clamp the ring-shaped member 4 and they are then fixed together by means of fixation elements 12, guide projections 14 provided on the outer circumference of the first frame 8, and handles 15 fixed inside the first frame 8.

The detailed structure of the screen member 5 will be described below.

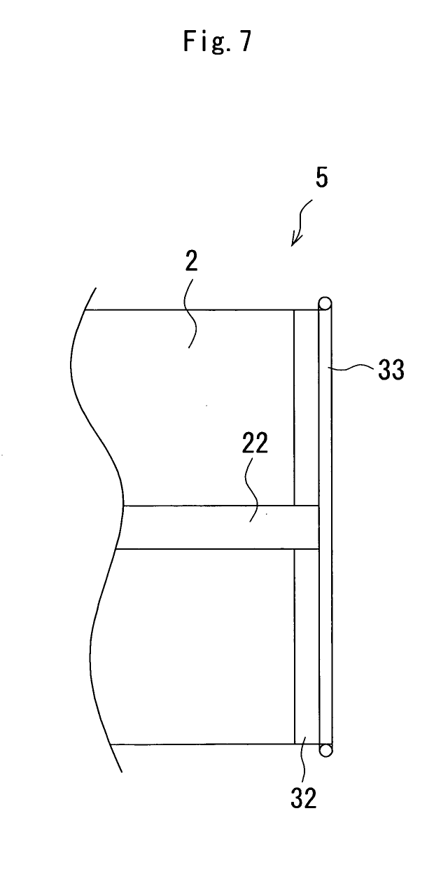

As shown in FIGS. 2(a) through 2(d), the screen member 5 is made by forming the screen 2 in a cylindrical shape, the screen 2 being made from a flexible material, for example, a fabric made from a synthetic resin such as polyester. The size of the screen member 5 may be any size suitable for a sieve specification depending on intended purposes. The screen member 5 is made by cutting out the screen 2 in a predetermined shape and then fixing the ring-shaped members 3 and 4 on both ends of the screen 2. The ring-shaped members 3 and 4 are members which will be held by said ring-shaped holder 6 in an attachable and detachable manner later. The screen 2 and the ring-shaped members 3 and 4 are then bended together in a shape of a cylinder while a seam 22 (see FIG. 7) is formed by jointing both radial direction ends 21 of the screen 2 in such a manner that the inner radial direction end 21 is not taken off from the outer radial direction end 21 due to the rotation of the rotating blades (not shown in the figure) of the inline type sifter (not shown in the figure) as shown in FIG. 2(c).

As shown in FIG. 2(b), the structure of the ring-shaped member 3 is a frame provided with a fixing part 32 made by sewing a reinforcement fabric 31 and the screen 2 together after the band-shaped insulating reinforcement fabric 31 made of synthetic resin such as vinylon being doubled back along the longitudinal direction and both ends of the screen 2 being inserted between the two ends of the reinforcement fabric 31, a ring 33 connected to the fixing part 32, and a core reinforcement 34 (for example, a rope) running through inside the ring 33. As shown in FIG. 2(d), the ring 33 is an unbroken ring located along the circumference of the screen 2. The ring-shaped member 3 is a frame having a circular shape when seen from a side, and has a sufficient hardness to hold the circular shape when being attached to or detached from the ring-shaped holder 6. The ring-shaped member 3 may be hollow; however, it is preferably reinforced by ring-shaped core reinforcement 34 inside it. The structure of the ring-shaped member 4 is similar to that of the ring-shaped member 3.

The screen 2 of the screen member 5 is a plane-woven screen consisted of nonconductive weaving threads made of synthetic resin and conductive weaving threads made of carbon fiber. Both warp threads and weft threads of the screen 2 are made of synthetic resin, and weaving threads made of carbon fiber are combined woven along with either the warp threads or the weft threads. For example, the screen 2 may be a screen consisted of a base nylon monofilament screen and carbon fiber weaving threads combined woven in one area of the base screen having an opening of 42 to 570 . . . m, or may be a screen consisted of a base polyester monofilament screen and carbon fiber weaving threads combined woven in one area of the base screen having an opening of 34 to 128 . . . m. The weaving thread made of synthetic resin may be made of polyethylene terephthalate (PET). In other words, the screen 2 of the screen member 5 is made of a plane-woven cloth consisted of nonconductive weaving threads and conductive weaving threads combined woven in them. The aperture rate and the opening of the screen member 5 may be any suitable values depending on intended purposes. However, the aperture rate is preferably 40 to 66%, and more preferably, 44 to 55%. For example, the screen member 5 may have a mesh of 16, an opening of 109 . . . m, a thread diameter of 0.5 mm, and an aperture rate of 47.1%. For another example, the screen member 5 may have a mesh of 34, an opening of 510 . . . m, a thread diameter of 0.245 mm, and an aperture rate of 51%. The conductive weaving threads may be made, for example, of conductive polyester monofilaments as described in Kokai (Japanese unexamined patent publication) No. H-08-074125.

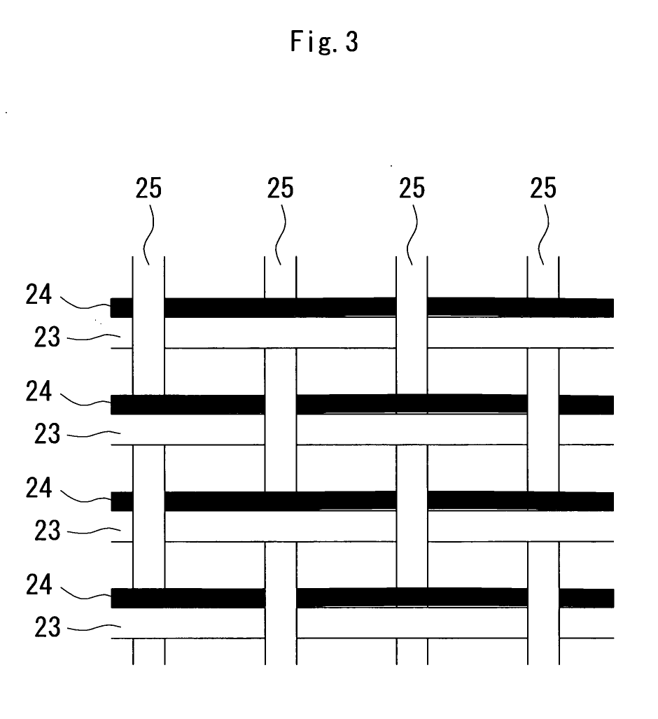

The detailed structure of the screen 2 will be described below with reference to FIG. 3. As shown in FIG. 3, the screen 2 is a plane fabric of a combined weave of nonconductive weaving threads 23 as warp threads, conductive weaving threads 24 as warp threads, and nonconductive weaving threads 25 as weft threads. Each conductive weaving thread 24 is coupled with one nonconductive weaving thread 23, and they are running together in the warp direction. In other area, where the screen 2 is not of combined weave, the screen 2 is plane-woven by using the nonconductive weaving threads 23 as warp threads and nonconductive weaving threads 25 as weft threads. In another embodiment, only conductive weaving threads 24 may be used as warp threads. The nonconductive weaving threads are preferably made of nylon, polyester and so on. The conductive weaving threads are preferably carbon fiber threads.

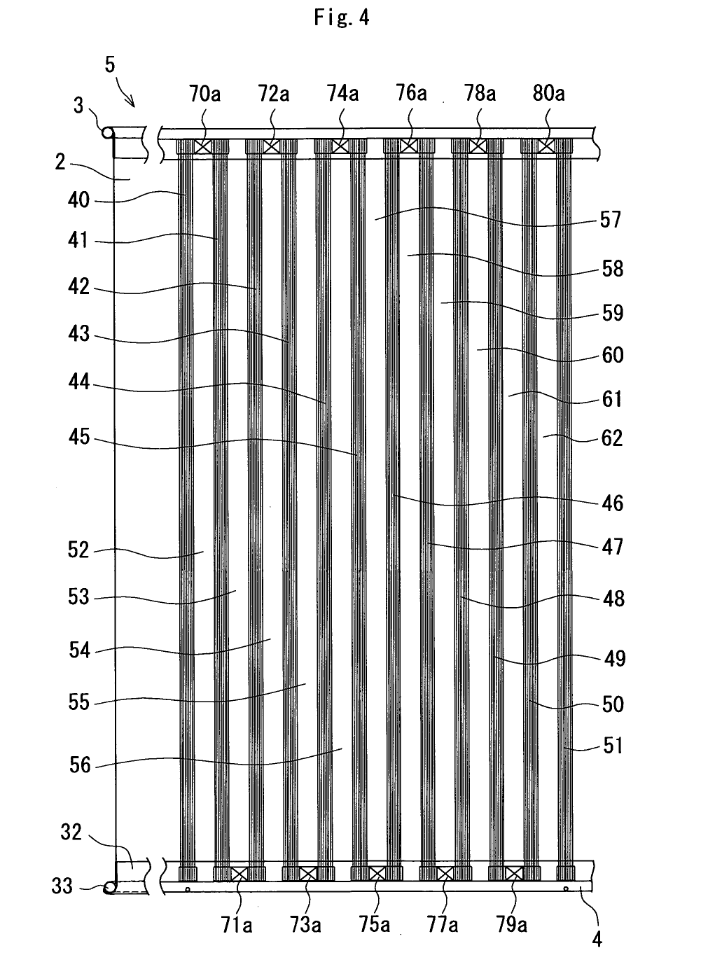

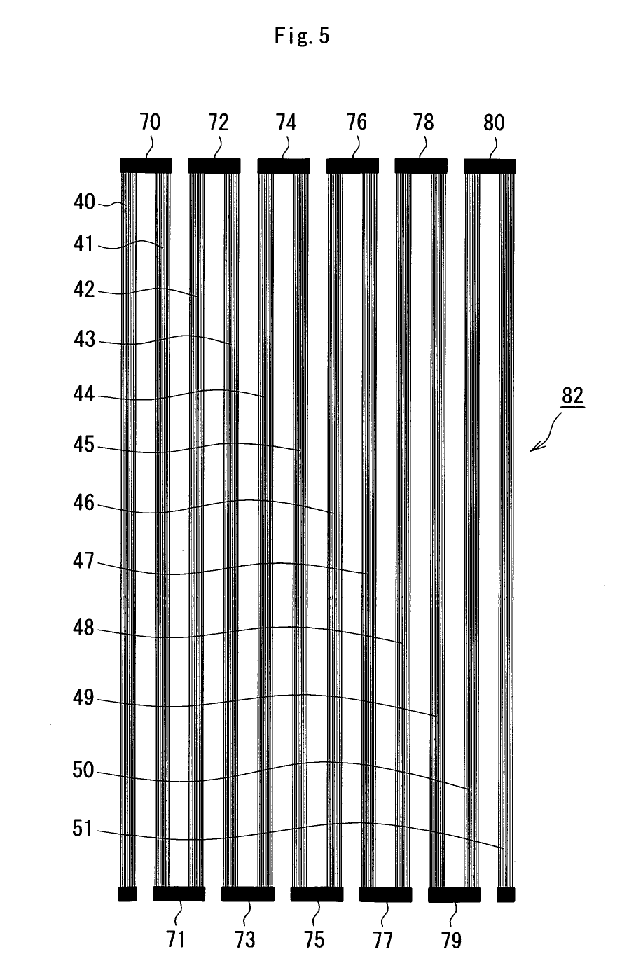

As shown in FIGS. 4 through 6, multiple conductive bands 40 through 51 of a predetermined width, composed of multiple (for example, nine, in the structure shown in the figures) conductive weaving threads 24 and multiple (for example, 10) nonconductive weaving threads 23 and a certain number of nonconductive weaving threads 25, are formed in one area of the screen member 5. These conductive bands 40 through 51 of combined weave are formed parallel to the axial direction X at certain intervals D. Between each conductive band 40 through 51, nonconductive bands 52 through 62 plane-woven by using the nonconductive weaving threads 23 and the nonconductive weaving threads 25 are formed. A continuous conductive element 82 of a folded shape is formed, as shown in FIGS. 4 and 5 by connecting adjacent ends of the multiple conductive bands 40 through 51 alternatively using conductive members 70 through 80 (conductive tapes made, for example, of thin cupper sheet). As shown in FIG. 4, the conductive members 70 through 80 are covered by insulating members 70a through 80a. In this embodiment, the longitudinal direction of the conductive members 70 through 80 is orthogonal to that of the conductive bands 40 through 51. The conductive element 82 has a folded shape in order that detected points are increased. Electrically, the longer the conductive element, the higher the resistance and the lower the voltage.

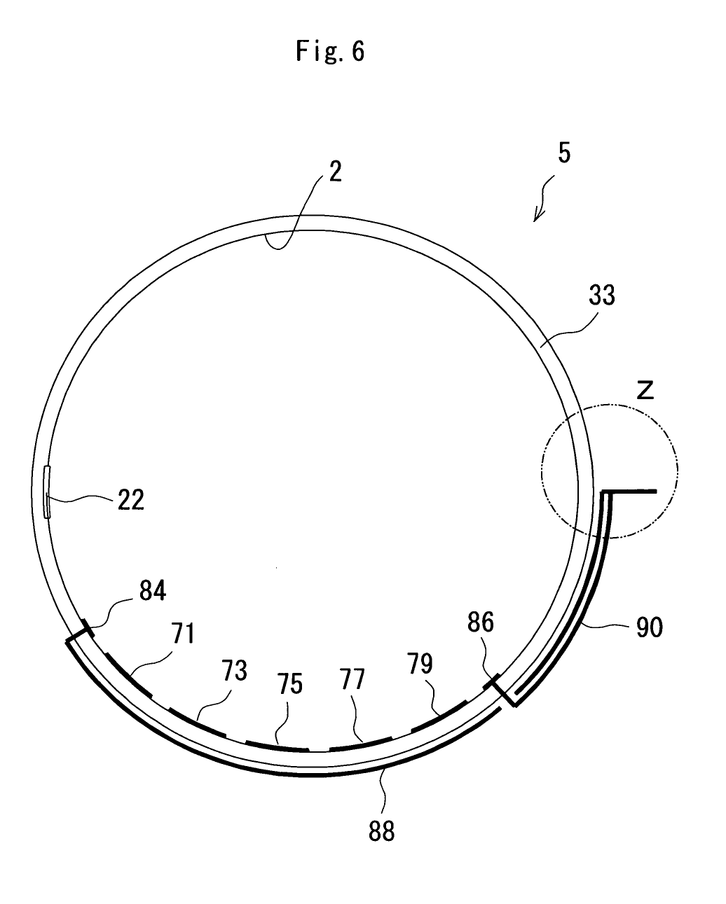

As shown in FIG. 6, the area of combined weave of the conductive weaving threads and nonconductive weaving threads is formed on the lower one forth of the screen 2 (center angle is 106°) where weight of particles are supported and probability of breakage is high. Another area is not of combined weave. The area of combined weave can be formed on any part of the screen 2. The conductive weaving threads 24 may be combined woven with the nonconductive weaving threads 23 and nonconductive weaving threads 25 all over the screen 2, in stead of only in some part of the screen member 5. As shown in FIGS. 4, 5 and 8, the insulating members 70a through 80a are covered and supported by the reinforcement cloth 31.

Opposing ends 84, 86 of the conductive element 82, from which conductive wires 88, 90 are wired, are formed in the ring-shaped member 3. As shown in FIGS. 9(a) and 9(b) which are the enlarged figures of the zone Z in FIG. 6, the conductive wire 88, 90 have respective electrodes 92, 94, the electrodes 92, 94 being protected by an insulator 96.

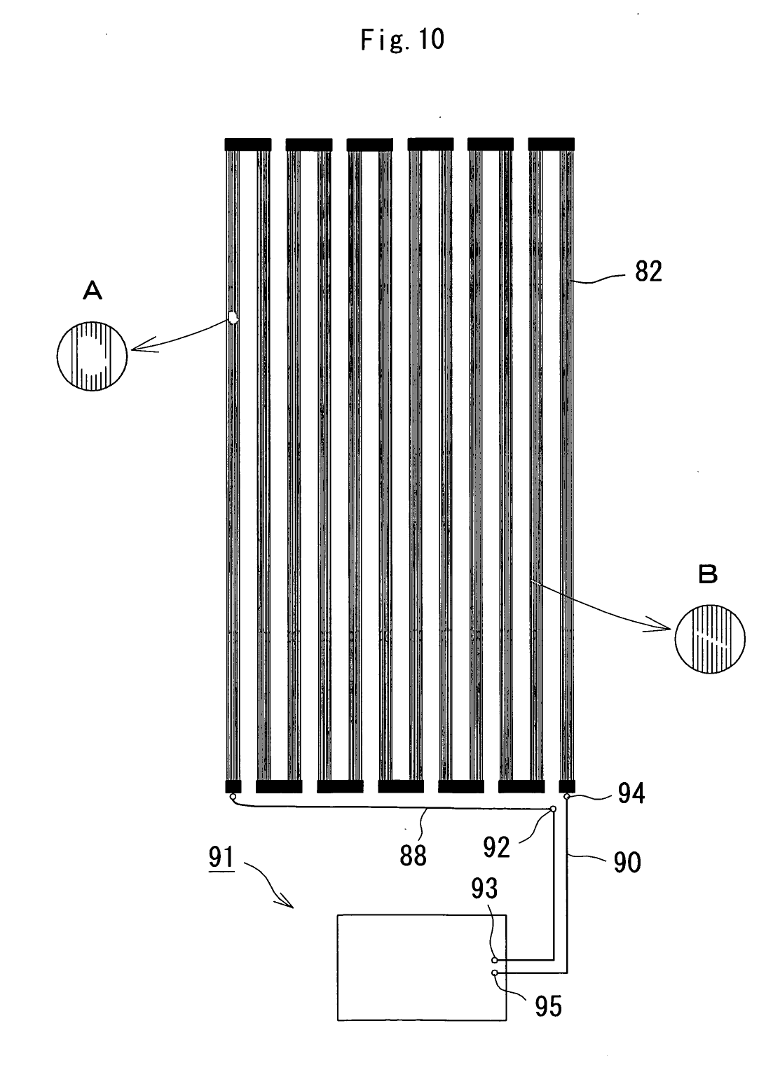

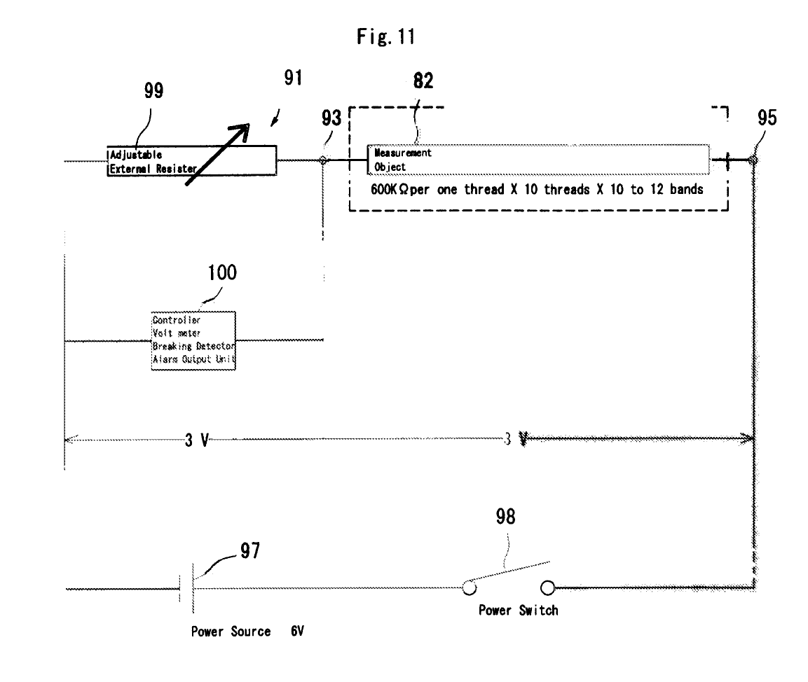

The structure of a sieve breakage detector 91 to be connected to the cylindrical sieve 1 will be described below with reference to FIGS. 10 and 11. The sieve breakage detector 91 is provided with terminals 93, 95 connected to not less than two points (to the electrodes 92, 94 in this embodiment) of the conductive element 82, a power source 97, a power switch 98 connected in series with the power source 97, an adjustable external resistor 99 used for calibration (for zero point adjustment), a control part 100 to be connected in parallel with the adjustable external resistor 99. The adjustable external resistor 99 (having a resistance of, for example, 2MΩ) and the control part 100 are in series with the conductive element 82, the power source 97 and the power switch 98. The conductive element 82 is composed of, for example, 10 to 12 conductive bands which are in turn composed of 10 conductive weaving threads having a resistance of 600 kΩ per one thread, and has a combined resistance of 600 kΩ to 1 kΩ. The control part 100 is provided with a controller, a voltmeter, a breaking detector, and an alarm output unit. Initial voltages are set at a predetermined value. In FIG. 11, the initial voltage applied to the conductive element 82 is 3V, and the voltage applied to the adjustable external resistor 99 is 3V.

During the operation of the sifter (not shown in figures), breakage of the screen is always monitored by measuring the voltage applied to the control part 100. If the screen 2 is broken and the conductive weaving thread(s) 24 is/are broken, the resistance is increased and the voltage applied to the control part 100 is decreased. If the measured voltage is decreased from the preset value (3V) more than a predetermined value, the control part 100 judges that breakage of the screen 2 has occurred in the area, and outputs an alarm by means of sounds and/or images and so on. The reason of breakage of the screen 2 includes, cut caused by a rotating element rotating inside the screen 2, perforation caused by wear by particles and so on. These breakages of the screen 2 can be detected by the sieve breakage detector 91. Accordingly, even if foreign materials such as a broken peace of the screen 2 passes through a broken point to get mixed into products, the products including foreign materials can be excluded. Safety of products, especially including foods and drugs, can be thus ensured.

In the breakage detector 91, the voltage applied to the control part 100 is measured by passing a minute current through the voltmeter of the control part 100 and by utilizing the change in the minute current. A voltmeter with high accuracy is preferable for this purpose. Breakage might not be detected by a voltmeter with normal accuracy. Multiple (nine in this embodiment) conductive weaving threads are provided in order to avoid the current becoming zero and the resistance becoming infinite when all conductive weaving threads are cut. The path of the conductive element 82 is long in order that wide detectable area may be assured and in order that pulsation width of voltage, when particles pass through, may be reduced as far as possible.

When the sifter (not shown in figures) is actually operated, air and particles are agitated together. This causes expansion and contraction of the screen 2 resulting in the pulsation of the voltage. It is necessary to detect voltage in such a dynamic condition. A vibration analysis, in which start of the feeder, the level of particles measured by a level meter, existence or absence of particles detected by a particle sensor, or other factors are taken into consideration as factors for judgment of a screen breakage, may be performed in order to enhance the accuracy of the judgment.

The control part 100 has a lower limit set as a threshold of voltage to judge a breakage of the screen 2, and judges that the screen 2 has a breakage when the measured voltage is lower than the lower limit of voltage. As multiple (nine in figures) weaving threads are provided, voltage can be measured as a whole, even if some of the weaving threads are cut. As control part 100 is connected to all of the ten weaving threads, it is not necessary to measure voltage of each weaving thread one-by-one.

In the case of an inline type sifter set in an automatic particle feeding line, breakage may be detected for each batch. If voltage changes beyond the threshold, and a signal indicating a breakage of the screen 2 is issued, for example, during the process of the fifth batch, only the fifth batch may be disposed as a waste. For this purpose, it is preferable to measure the start time and end time of each batch and the breakage time of the screen 2 to determine which batch the breakage time belongs to. Examples of breakage of the screen 2 are shown in FIG. 10. FIG. 10 A shows an example of a hole caused by wearing. FIG. 10 B shows an example of cut caused by the rotating blades.

Resistance may be measured in stead of voltage. For this purpose, an adjustable external resistor 99 is to be removed, the control part 100 be connected in parallel to the conductive element 82, and the voltmeter in the control part 100 be replaced by a resistance meter. In this case, resistance of the conductive element 82 is measured by passing minute electric current through the resistance meter in the control part 100 and by utilizing the change in the minute electric current. Breakage of the screen 2 leads to an increase in resistance. Accordingly, in this configuration, an upper limit is set preliminary, and when measured resistance exceeds the upper limit, it is judged that breakage of the screen 2 has occurred. A resistance meter with high accuracy is preferable for this purpose. Breakage might not be detected by a resistance meter with normal accuracy. Multiple (nine in this embodiment) conductive weaving threads are provided in order to avoid the resistance becoming infinite when all conductive weaving threads are cut.

In the embodiment described above, the screen member 5 is made of one screen 2. The screen member 5, however, may be made of two screens separated by, for example, an intermediate frame. As for the structure of the screen 5, please refer to an embodiment shown in FIG. 1 of the International Publication WO2004/060584A1, for example. As for the detailed structure to set the cylindrical sieve 1 to an inline type sifter, please refer to the International Publication WO2004/060584A1.

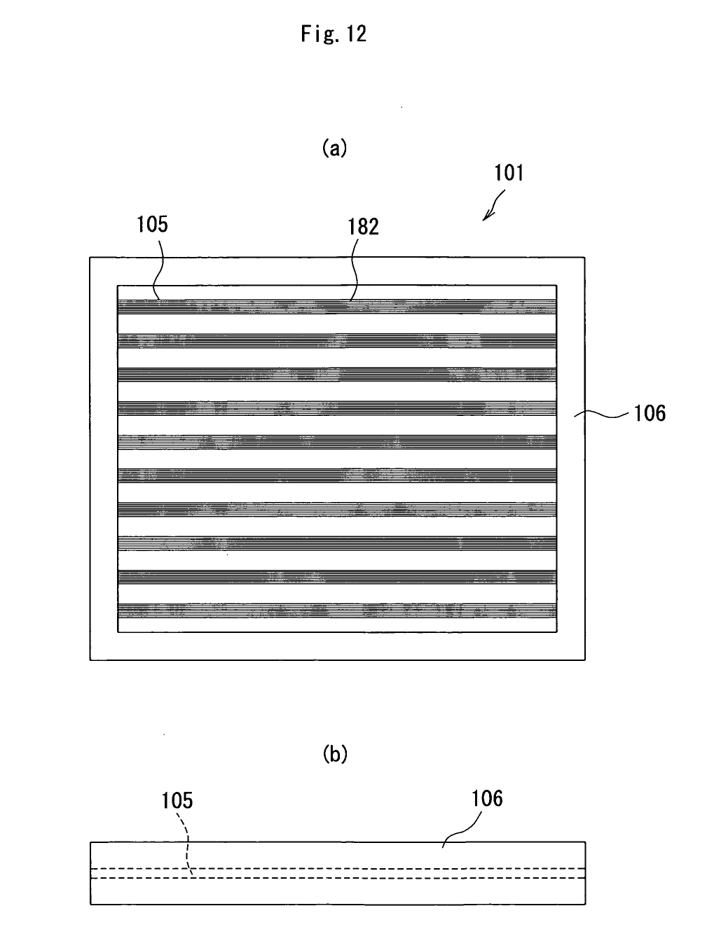

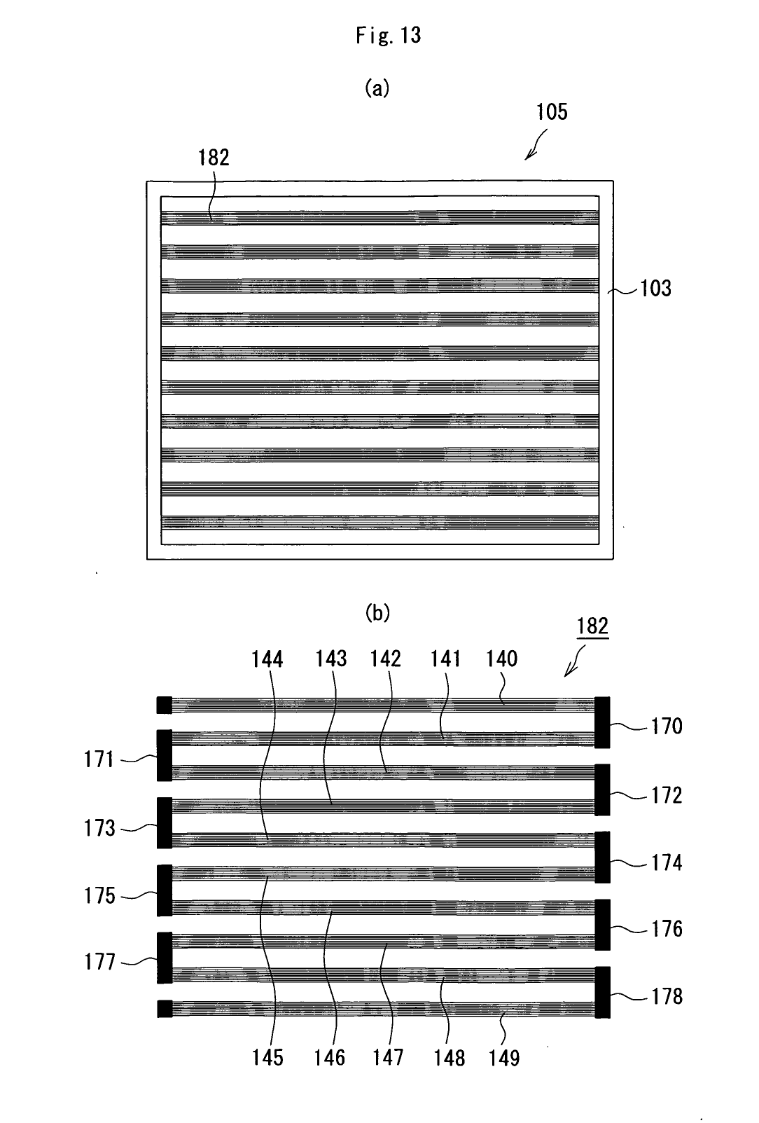

A polygonal vibration sieve 101 in a second embodiment of the invention is described below with reference to the FIG. 12 and FIG. 13. The vibration sieve 101 may be polygonal or circular. The structure of the vibration sieve 101 in this second embodiment is almost similar to the cylindrical sieve in the first embodiment. Explanation for the cylindrical sieve applies mutatis mutandis to this embodiment. Reference numbers in this embodiment are numbered with 100 added to the corresponding reference numbers in the first embodiment. However, a polygonal frame-shaped holder 106 is used in this embodiment instead of the ring-shaped holder 6.

As for examples of structure to set the vibration sieve 101 to a vibration sifter, please refer to Kokai (Japanese unexamined patent publication) No. H-9-122592, Kokai (Japanese unexamined patent publication) No. H-11-128842 and others.

The embodiments discussed above are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

The disclosure of Japanese Patent Application No. 2004-303581 filed Oct. 18, 2004 including specification, drawings and claims is incorporated herein by reference in its entirety.

1. A sieve comprising a cylindrical or plane screen woven with nonconductive warp threads and nonconductive weft threads,
wherein multiple bands composed of one or more conductive weaving thread(s) are combined woven all over said screen or in an area of said screen along with either the warp threads or the weft threads of said screen, and
a continuous conductive element of a folded shape is formed by connecting adjacent ends of said multiple bands alternatively using (a) conductive member(s).

2. A sieve in accordance with claim 1,
wherein a ring-shaped member is formed at both ends of the axial direction of said cylindrical screen or a frame-shaped member is formed around said plain screen,
said ring-shaped member or said frame-shaped member is supported by a holder in a attachable and detachable manner,
said holder holds ends of said conductive element, and
said conductive member is protected by an insulating member.

3. A sifter comprising the sieve in accordance with claim 1.

4. A sieve breakage detector comprising:
a resistance meter or a voltmeter which is provided with terminals connected to at least two points of said conductive element of the sieve in accordance with claim 2 and which measures resistance or voltage of said conductive element, and
a judging part which judges that breakage has occurred in said area of the screen when the measured resistance or voltage changes greater than a preset value.
